(19) United States
(12) Patent Application Publication
(10) Pub. No.: US 2020/0061918 A1
(43) Pub. Date: Feb. 27, 2020

(54) MIXING POWDERED BUILD MATERIAL FOR ADDITIVE MANUFACTURING

(71) Applicant: HEWLETT-PACKARD DEVELOPMENT COMPANY, L.P., Houston, TX (US)

(72) Inventors: Bradley B. Branham, Vancouver, WA (US); Justin M. Roman, Portland, OR (US); Wesley R. Schalk, Camas, WA (US)

(21) Appl. No.: 16/070,760

(22) PCT Filed: Apr. 30, 2016
(86) PCT No.: PCT/US2016/030330

§ 371 Date: Jul. 17, 2018

(51) Int. Cl. B29C 64/314; B29C 64/205; B29C 64/329; B29C 64/255; B29C 64/393

(52) U.S. Cl. CPC B29C 64/314; B29C 64/205; B33Y 30/00; B29C 64/255; B29C 64/393; B29C 64/329

(57) ABSTRACT

In one example, a build material supply system for additive manufacturing includes a mixer to aperiodically rotate a non-circular mixing chamber containing powdered build material to form mixed powdered build material.

### BACKGROUND

Additive manufacturing machines, sometimes called 3D printers, produce objects by building up layers of material. Digital data may be processed into slices each defining that part of a layer or layers of build material to be formed into the object. In some additive manufacturing machines, the object slices are formed in a powdered build material spread in layers over the work area. Heat may be used to fuse together the particles in each of the successive layers of powder to form a solid object. Heat to fuse build material in each layer may be generated, for example, by applying a liquid fusing agent to the powder in the pattern based on a single slice of the object and then exposing the patterned area to a light or other energy source. The fusing agent absorbs energy to help sinter, melt or otherwise fuse the patterned powder. Manufacturing may proceed layer by layer and slice by slice until the object is complete.

### DRAWINGS

FIGS. 1 and 2 are block diagrams illustrating an additive manufacturing machine implementing one example of a powdered build material supply system.

FIG. 3 is a block diagram illustrating an example powdered build material supply system in more detail.

FIGS. 4-6 illustrate one example of a mixer such as might be implemented in a powdered build material supply system for additive manufacturing.

FIG. 7 is a block diagram illustrating another example powdered build material supply system.

FIGS. 8-12 illustrate one example of a mixer such as might be implemented in a powdered build material supply system for additive manufacturing.

### DESCRIPTION

The use of multi-component powders for additive manufacturing is increasing as manufacturers seek to improve quality and expand production to include a greater variety of “printed” parts. The component particles in such powders, however, may segregate during transportation and storage. Also, particles in a bulk supply of some powdered build materials tend to agglomerate when not actively mixed. Thus, for many additive manufacturing machines that use powdered build material, it usually will be desirable to thoroughly mix the powder before layering and fusing. The inventors have discovered that inducing a chaotic advection in the powder inside a supply container enables fast and thorough mixing “on demand” before powder is dispensed for layering and fusing. Accordingly, a chaotic advection mixer may be implemented in the manufacturing machine itself, using interchangeable supply modules for example, to help increase throughput and improve powder handling efficiency.

The examples described below and shown in the figures illustrate but do not limit the scope of the patent, which is defined in the Claims following this Description.

As used in this document: “agitate” means to move simultaneously in more than one degree of freedom of motion; “and/or” means at least one of the connected things; “non-circular” means not circular in any cross-section orthogonal to the axis of rotation; “irregular shape” means a shape that has a cross-section orthogonal to the axis of rotation with at least one straight line and at least one curve; a “processor readable medium” is any non-transitory tangible medium that can embody, contain, store, or maintain instructions for use by a processor; and “work area” means any suitable structural area to support or contain build material for fusing, including underlying layers of build material and in-process slice and other object structures.

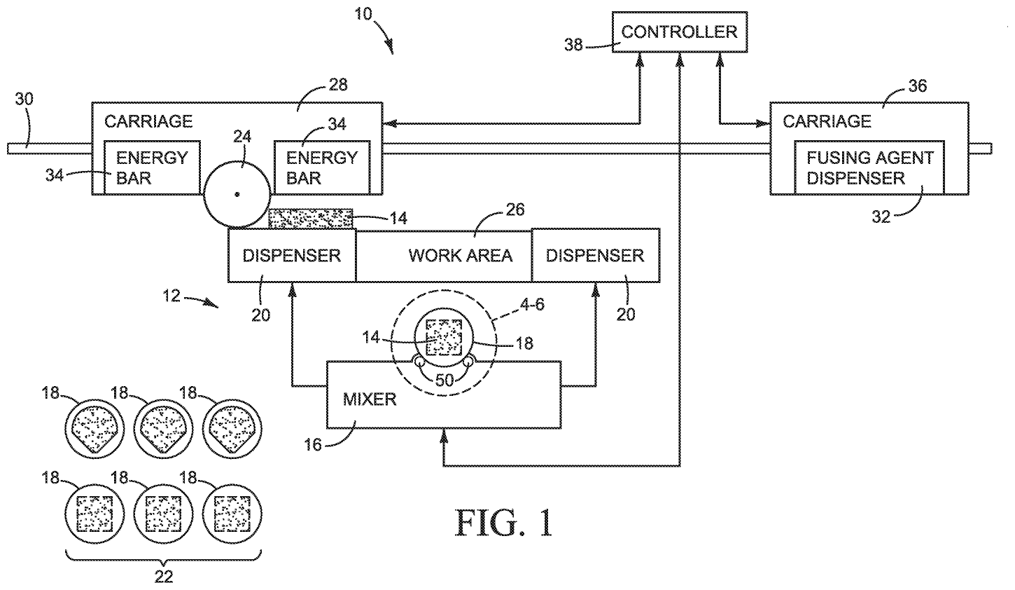

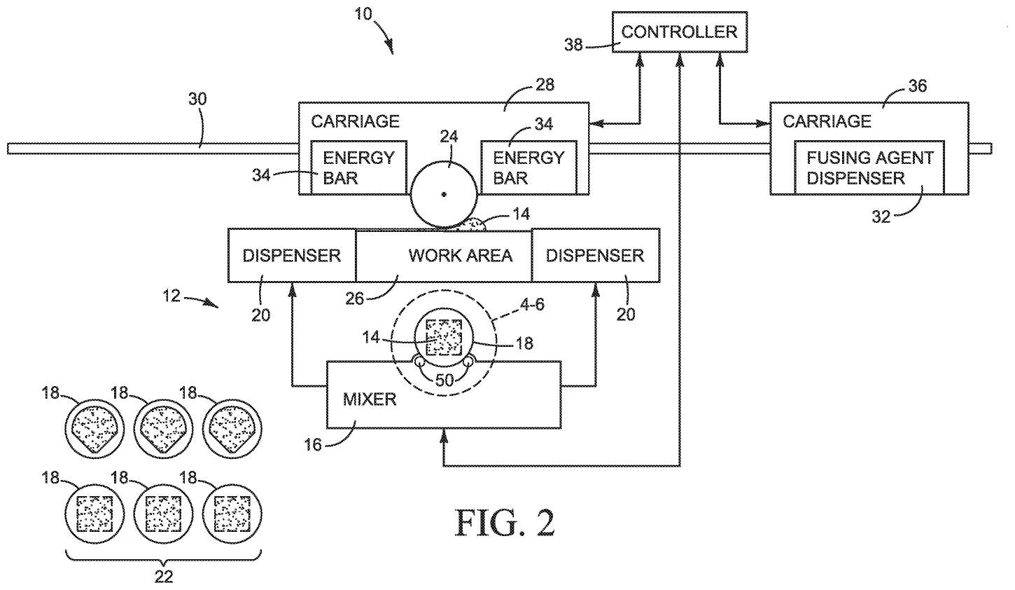

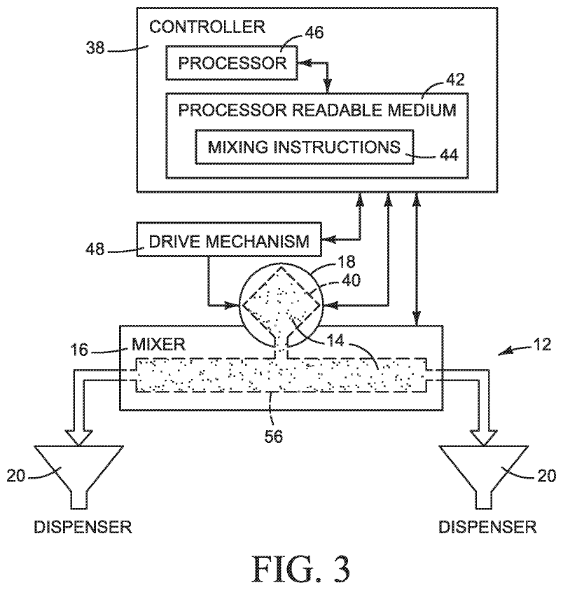

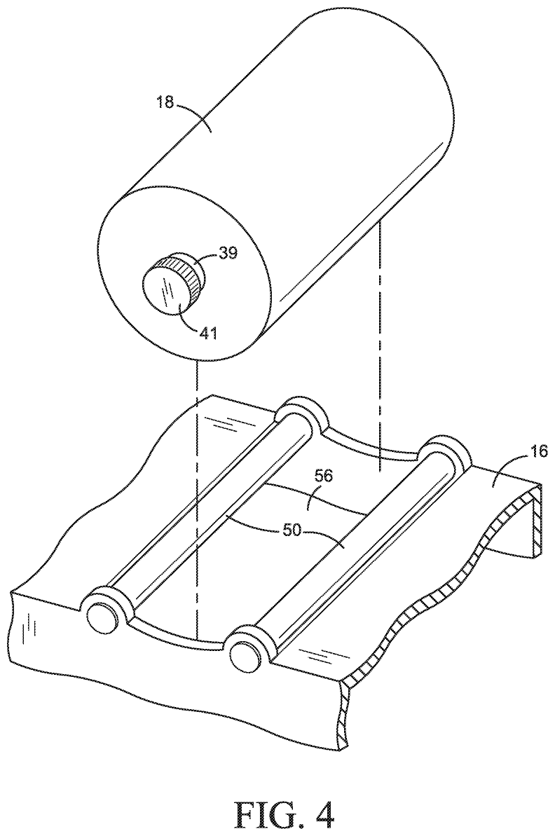

FIGS. 1 and 2 are block diagrams illustrating an additive manufacturing machine 10 implementing one example of a powdered build material supply system 12. FIG. 3 is a block diagram illustrating an example supply system 12 in more detail. FIGS. 4-6 are details of the example mixer in system 12 shown in FIGS. 1 and 2. Machine 10 in FIGS. 1 and 2 is just one example of an additive manufacturing machine for implementing a supply system 12. Examples of a supply system 12 may be implemented in other types or configurations of additive manufacturing machines.

Referring first to FIGS. 1 and 2, additive manufacturing machine 10 includes a supply system 12 to supply powdered build material 14 to a work area 26. In the example shown, build material supply system 12 includes a mixer 16, a powder supply module 18 in mixer 16, and dispensers 20 operatively connected to mixer 16. As described in detail below with reference to FIGS. 3-6, mixer 16 and supply module 18 together are configured to induce a chaotic advection of build material powder 14 inside module 18 While a single powder supply module 18 may be used, it is expected that a supply system 12 usually will include a group 22 of interchangeable supply modules 18 that may each be loaded in to mixer 16 to supply powder to dispensers 20 and unloaded from mixer 16 when depleted, to be replaced with a full module. Each supply module 18 in the group may itself be a disposable module or a refillable, reusable module.

Each dispenser 20 may be implemented, for example, as a supply tray, feed cartridge, hopper or other dispensing device that presents build material 14 to a spreader roller 24 or other suitable layering device for layering build material 14 on to a work area 26, as shown in FIG. 2. In other examples, a dispenser 20 may dispense layers of build material 14 directly on to work area 26. In the example shown, spreader roller 24 is mounted to a movable carriage 28 that carries roller 24 back and forth over work area 26, for example along a rail 30. In the example shown, a dispenser 20 is located at each side of work area 26 so that build material 14 can be presented to spreader roller 24, and thus layered on to work area 26, as roller 24 passes alternately back and forth over the work area. In other examples, a single dispenser 20 may be located on one side of work area 26 so that build material can be presented to spreader roller 24, layered on to work area 26, and excess build material 14 returned to dispenser 20. As noted above, work area 26 in the figures represents any suitable structure to support or contain build material for fusing, including underlying layers of build material and in-process slice and other object structures. For a first layer of build material, for example, work area 26 may be formed on the surface of a platform that moves up and down to adjust the thickness of each layer. For succeeding layers of build material, for example, work area 26 may be formed on the underlying layer (or layers) of build material, which may include fused and unfused build material.

Additive manufacturing machine 10 also includes a fusing agent dispenser 32 and a source 34 of light or other fusing energy. In this example, fusing agent dispenser 32 is mounted to a movable carriage 36 that carries dispenser 32 back and forth over work area 26 on rail 30. Also, in this example, energy source 34 is implemented as a pair of energy bars 34 mounted to roller carriage 28. A programmable controller 38 includes the processing resources, memory and instructions, and the electronic circuitry and components needed to control the operative elements of machine 10 according to the control data and other instructions to manufacture an object.

In operation, build material 14 is mixed in supply module 18 and conveyed to dispensers 20 from module 18 directly or through mixer 16. Any suitable conveyance may be used. Each dispenser 20 presents the build material alternately to spreader roller 24 for layering over work area 26. A fusing agent is selectively applied to layered build material in a pattern corresponding to an object slice, as fusing agent dispenser 32 on carriage 36 is moved over work area 26. One or both energy bars 34 are energized to expose the patterned area to light or other electromagnetic radiation to fuse build material where fusing agent has been applied, as carriage 28 carrying energy bars 34 is moved over work area 26. The fusing agent absorbs energy to help sinter, melt or otherwise fuse the patterned build material. Manufacturing proceeds layer by layer and slice by slice until the object is complete.

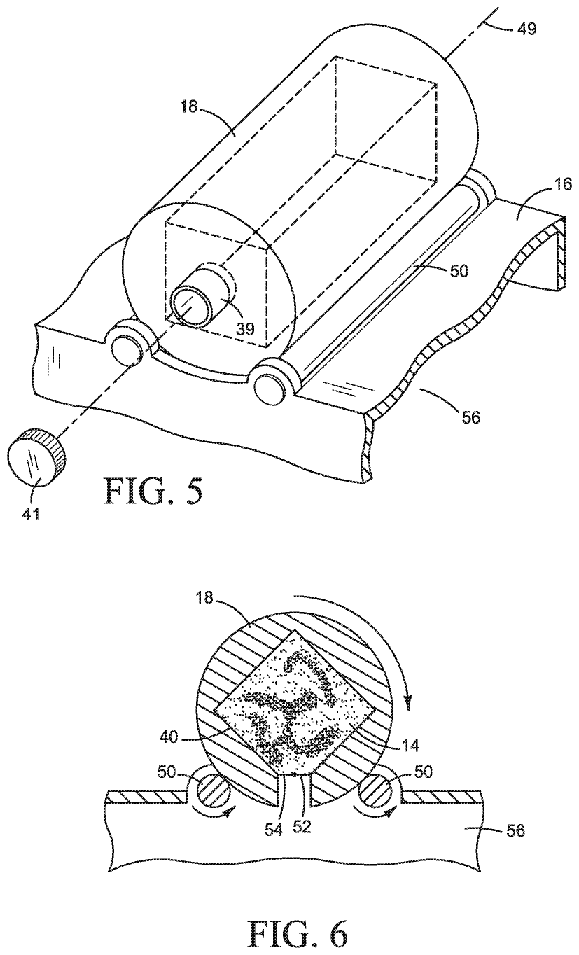

Referring now also to FIGS. 3-6, each module 18 includes an interior mixing chamber 40 to hold powdered build material 14. Each module 18 may also include a fill port 39, shown capped in FIG. 4 (with a cap 41). Programmable controller 38 includes a processor readable medium 42 with mixing instructions 44 and a processor 46 to execute instructions 44. Mixer 16 includes a drive mechanism 48 to move module 18 according to mixing instructions 44 on controller 38. A chaotic advection may be induced in powder 14 in a module 18 through a combination of mixing chamber geometry and motion, for example by rotating a non-circular mixing chamber aperiodically about an axis of rotation 49 (FIG. 5). Thus, in the example shown in FIGS. 4-6, drive mechanism 48 is implemented as a pair of drive rollers 50 to aperiodically rotate a cylindrical supply module 18 with powder 14 in a square mixing chamber 40, at the direction of controller 38 executing mixing instructions 44 in FIG. 3. Any suitable motor, motor controller and drive train may be used to turn rollers 50, together or independently, to achieve the desired rotation. Although ten motion cycles are described, more or fewer motion cycles may be used to achieve the desired mixing.

Aperiodic rotation may be achieved by intermittently varying the angular velocity, the angular displacement, and /or the direction of rotation of mixing chamber 40 through a number of cycles or for a duration corresponding to the desired mixing. In one example, which may be suitable for mixing a polymer based powder 14 in a square mixing chamber 40, mixing chamber 40 is rotated in the following sequence in which both the angular velocity, the angular displacement and the direction of rotation are varied aperiodically throughout a sequence of 10 cycles (a negative displacement indicates counter-clockwise rotation):

1. rotate clockwise 5 radians at 7 radians/second (time=0.7 s);

2. rotate counter-clockwise −7 radians at 6 radians/second (time=1.2 s),

3. rotate clockwise 1 radian at 10 radians/second (time=0.1 s),

4. rotate clockwise 21 radians at 5 radians/second (time=4.2 s);

5. rotate counter-clockwise −15 radians at 4 radians/second (time=3.8 s);

6. rotate clockwise 22 radians at 10 radians/second (time=2.2 s);

7. rotate counter-clockwise −5 radians at 9 radians/second (time=0.6 s);

8. rotate clockwise 21 radians at 2 radians/second (time=10.5 s),

9. rotate counter-clockwise −18 radians at 9 radians/second (time=2.0 s), and

10. rotate counter-clockwise −13 radians at 7 radians/second (time=1.9 s). The angular displacement may be determined directly or the duration of each time interval may be used to determine the angular displacement. That is to say, a motor controller may be programmed to rotate the mixing chamber through a certain angular displacement at the desired angular speed or the motor controller may be programmed to rotate the mixing chamber for a certain time at the desired angular velocity to achieve the desired angular displacement.

Aperiodic angular displacement θᵢ a may be determined, for example, according to Equation 1.

θᵢ=θᵢ₋₁+[sgn(f_{A}([−1, 1]))*(θₘₐₓ−θₘᵢₙ)*f_{B}([0, 1])] Equation 1:

where θₘₐₓ and θₘᵢₙ define the allowable range of angular displacement, f_{B}([0,1]) is a probability distribution function to generate a random real number between 0 and 1 inclusive, and sgn(f_{A}([−1,1])) determines the direction of rotation according to a probability distribution function f_{A}([-1,1]). An aperiodicity algorithm such as that described by Equation 1 may be implemented, for example, in mixing instructions 44 on controller 38 in FIG. 3.

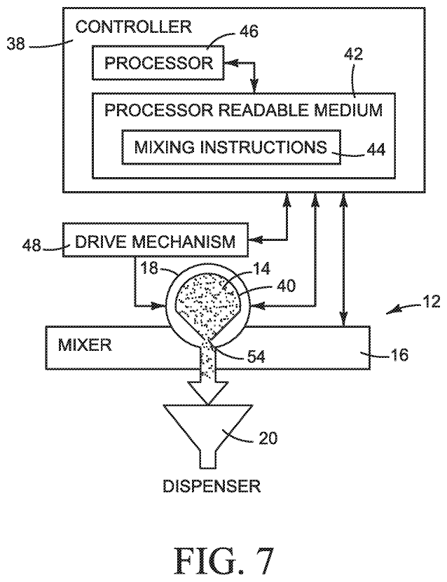

While each supply module 18 in a group 22 in FIGS. 1 and 2 is interchangeable in mixer 16 with the other modules in the group, modules 18 need not be identical. As shown in FIGS. 1 and 2, for example, the geometry of the interior mixing chamber 40 may be different. To the extent differently shaped mixing chambers among modules 18 in a group 22 utilize different mixing algorithms to achieve a desire aperiodicity, controller 38 may be programmed with the corresponding mixing instructions 44. The mixing flow of powder 14 inside chamber 40 is represented by regions of swirling darker stippling in FIG. 6. The actual flow pattern for any particular powder 14 inside a non-circular mixing chamber 40 rotating aperiodically, for example according to algorithm 100 in FIG. 7, is difficult to ascertain without complex testing. Thus, the representation of the mixing flow in FIG. 6 is intended to suggest a chaotic advection type mixing flow generally, and does not depict an actual flow pattern.

As shown in FIG. 6, where mixed powder is to be collected in mixer 16 for conveyance to dispensers 20, supply module 18 may include a valve 52 to dump or otherwise discharge mixed powder through an outlet 54 into a reservoir 56 in mixer 16. In this example, outlet 54 is located at a corner, where the sidewalls converge in a hopper feature 58 that funnels powder 14 to outlet 54. A fill port 39 shown in FIG. 4 could also be used to discharge mixed powder from mixing chamber 40 directly to dispensers 20. As noted above, any suitable conveyance may be used to move mixed powder from mixing chamber 40 to dispensers 20 directly or indirectly through mixer 16. Suitable conveyances may include, for example, augers, pneumatics, and gravity.

While a single mixer 16 is shown serving multiple dispensers 20 in the figures, more or few mixers and dispensers could be used. For example, an additive manufacturing machine 10 could include a mixer 16 for each of multiple dispensers 20. Also, a mixer 16 may be configured to load multiple powder supply modules 18 simultaneously, for example to increase the capacity of the mixer without also increasing the size of the individual supply modules.

Testing suggests the smooth, symmetrical flows in circular mixing chambers with constant or even periodic rotation can induce distinct shear layers that inhibit effectively mixing some powdered build materials. More effective mixing may be achieved using a non-circular or irregular shaped mixing chamber with aperiodic rotation, even when the mixing chamber is substantially full of powder thus enabling greater capacity for each supply module 18. Adding corners to the mixing chamber and aperiodicity to the rotation cause shear layers in the powder to cross unpredictably, thus inducing a chaotic advection to help improve mixing.

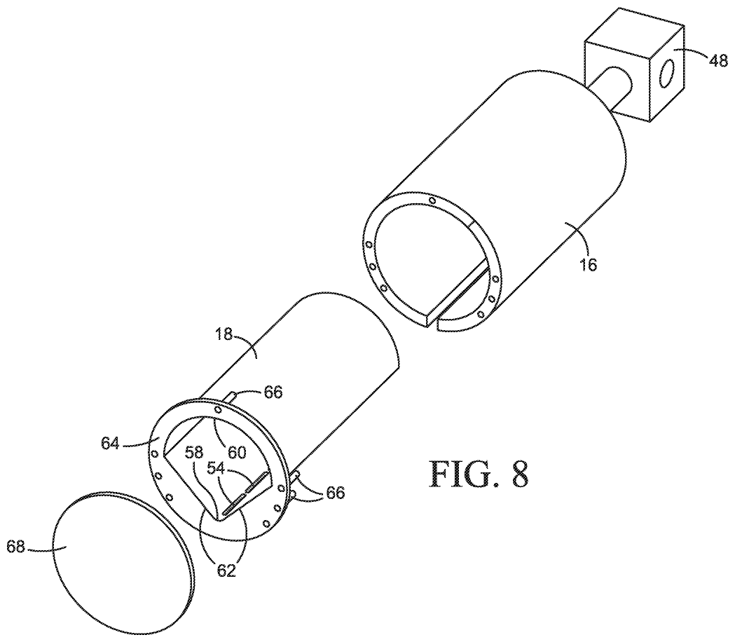

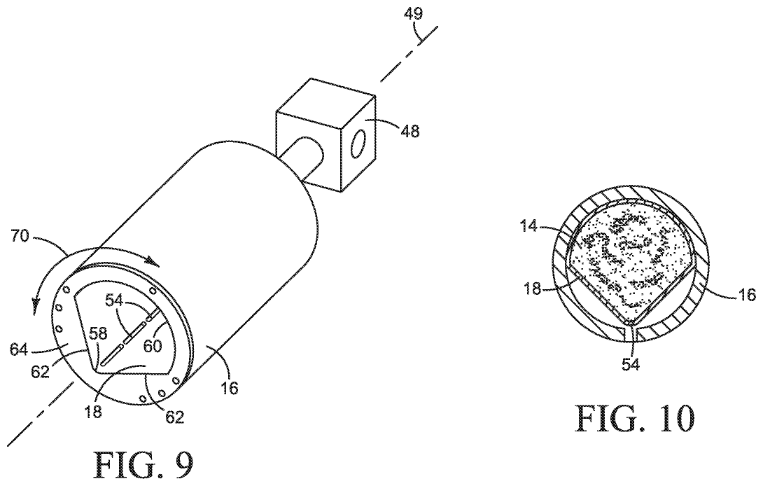

In another example, shown in FIGS. 7-12, a supply module 18 includes an irregularly shaped mixing chamber 40 defined by an arc 60 and two straight lines 62. Straight lines 62 converge at outlet 54 to form a hopper feature 58 that funnels powder 14 to outlet 54. In this example, mixer 16 is implemented as a cylindrical sleeve and supply module 18 is implemented as an insert to mixer sleeve 16. As best seen in the exploded view of FIG. 8, supply module insert 18 includes a flange 64 that abuts the end of mixer sleeve 16. Pins or screws 66 around flange 64 may be used to connect insert 18 to sleeve 16. A removable cover 68 shown in FIG. 9 opens and closes mixing chamber 40.

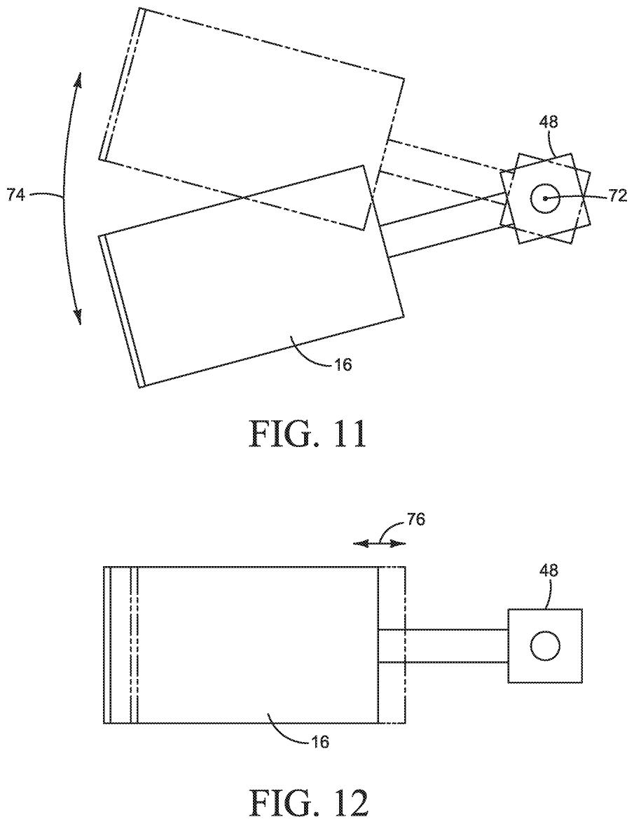

Drive mechanism 48 connected to sleeve 16 is configured to agitate supply module insert 18 at the direction of controller 38 executing mixing instructions 44. As noted above, “agitate” means to move simultaneously in more than one degree of freedom of motion. In this example, drive mechanism 48 is configured to move supply module insert 18 (through sleeve 16) in three degrees—rotating module 18 on an axis 49, as indicated by arrow 70 in FIG. 9, pivoting module 18 about an axis 72, as indicated by arrow 74 in FIG. 11, and translating module back and forth, as indicated by arrow 76 in FIG. 12. Alternate positions for module 18 are depicted by phantom lines in FIGS. 11 and 12 for pivoting and translating.

An agitating mixer such as that illustrated in FIGS. 8-13 enables more flexibility for delivering aperiodic motion to module 18, and thus for inducing chaotic mixing in powder 14, compared to a single motion mixer, although the aperiodic motion of mixer 16 in FIGS. 7-12 could, in some examples, be limited to only rotation. Aperiodicity may be achieved by aperiodic motion in at least one degree of motion, for example using the aperiodicity algorithms noted above, as well as by an aperiodic combination of constant or periodic motion in more than one degree of motion. Aperiodicity algorithms such as those described by Equations 1 and 2 may be implemented, for example, in mixing instructions 44 on controller 38 in FIG. 7.

The examples shown in the figures and described above illustrate but do not limit the patent, which is defined in the following Claims.

“A”, “an”, and “the” as used in the Claims means at least one.

1. A powdered build material supply system for additive manufacturing, comprising:
a mixer; and
a controller operatively connected to the mixer to rotate the mixing chamber aperiodically by varying an angular displacement of the mixing chamber aperiodically during a series of rotation cycles, by varying an angular speed of the mixing chamber aperiodically during the series of rotation cycles, and/or by varying a direction of rotation of the mixing chamber aperiodically during the series of rotation cycles.

2. The system of claim 1, comprising a non-circular mixing chamber to hold powdered build material in the mixer.

3. The system of claim 1, where the controller is programmed to rotate the mixing chamber aperiodically by varying the angular displacement according to the equation
θᵢ=θᵢ₋₁+[sgn(f_{A}([−1, 1]))*(θₘₐₓ−θₘᵢₙ)*f_{B}([0, 1])]
where θₘₐₓ and θₘᵢₙ define an allowable range of angular displacement, f_{B}([0,1]) is a probability distribution function to generate a random real number between 0 and 1 inclusive, and sgn(f_{A}([−1,1])) determines a direction of rotation according to a probability distribution function f_{A}([−1,1]).

4. The system of claim 2, where the mixing chamber is rectangular or irregularly shaped.

5. The system of claim 4, where the mixing chamber includes:
an outlet through which powdered build material may flow out of the chamber; and
a hopper feature to funnel powdered build material to the outlet.

6. The system of claim 5, where the mixing chamber is defined by an arc and two straight lines that converge at the outlet and the hopper feature is defined by the two straight lines that converge at the outlet.

7. The system of claim 2, comprising multiple interchangeable supply modules each defining a non-circular interior mixing chamber to hold powdered build material and each module being removably loadable into in the mixer.

8. The system of claim 2, comprising a dispenser operatively connected to the mixer to receive powdered build material from the mixing chamber and to dispense mixed powdered build material for fusing.

9. A build material supply system for additive manufacturing, comprising:
a mixer to aperiodically rotate a non-circular mixing chamber containing powdered build material to form mixed powdered build material; and
a dispenser operatively connected to the mixer to dispense mixed powdered build material for fusing.

10. The system of claim 9, where the mixer is to agitate the non-circular mixing chamber containing powdered build material to form the mixed powdered build material.

11. A processor readable medium having mixing instructions thereon that when executed cause a mixer in an additive manufacturing machine to rotate a non-circular mixing chamber aperiodically by varying an angular displacement of the mixing chamber aperiodically during a series of rotation cycles, by varying an angular speed of the mixing chamber aperiodically during the series of rotation cycles, and/or by varying a direction of rotation of the mixing chamber aperiodically during the series of rotation cycles.

12. The processor readable medium of claim 11, where the mixing instructions include instructions to rotate the mixing chamber aperiodically by varying the angular displacement Δθᵢ according to the equation
θᵢ=θᵢ₋₁+[sgn(f_{A}([−1, 1]))*(θₘₐₓ−θₘᵢₙ)*f_{B}([0, 1])]
where θₘₐₓ and θₘᵢₙ define an allowable range of angular displacement, f_{B}([0,1]) is a probability distribution function to generate a random real number between 0 and 1 inclusive, and sgn(f_{A}([−1,1])) determines a direction of rotation according to a probability distribution function f_{A}([−1,1]).

13. The processor readable medium of claim 11, where the mixing instructions include instructions to agitate the mixing chamber.

14. An additive manufacturing machine controller that includes the processor readable medium of claim 11.
